(19) United States
(12) Patent Application Publication
(10) Pub. No.: US 2015/0181136 A1
(43) Pub. Date: Jun. 25, 2015

(54) METHOD AND SYSTEM FOR DETECTING CONCEALED OBJECTS USING HANDHELD THERMAL IMAGER

(71) Applicants: Michael A. Reinpoldt, Windermere, FL (US); Willem H. Reinpoldt, III, Tarpon Springs, FL (US); Richard J. Salem, Tampa, FL (US)

(72) Inventors: Michael A. Reinpoldt, Windermere, FL (US); Willem H. Reinpoldt, III, Tarpon Springs, FL (US); Richard J. Salem, Tampa, FL (US)

(73) Assignee: Thermal Matrix USA, Inc., Clearwater, FL (US)

(21) Appl. No.: 13/074,305

(22) Filed: Mar. 29, 2011

(51) Int. Cl. H04N 5/33; H04N 5/232

(52) U.S. Cl. CPC H04N 5/33; H04N 5/23293

(57) ABSTRACT

A method and system for detecting concealed objects using a handheld thermal imager is disclosed. In a particular embodiment, the method includes capturing thermal sensor data from the handheld thermal imager, transmitting the thermal sensor data to a processor, and formatting the sensor data using the processor. The method also includes identifying a pre-determined relative difference between a temperature of a subject and a background scene and isolating the subject of interest from the background scene in the thermal sensor data using the processor. In addition, the method includes detecting a deviation in the temperature within a discrete area to suggest a size and location of the concealed object on the subject and filtering the thermal sensor data to generate a visual image displaying the concealed object on the subject of interest.

### I. FIELD

The present invention relates in general to the field of security systems, and in particular to a method and system for detecting concealed objects using a handheld thermal imager.

### II. DESCRIPTION OF RELATED ART

A wide variety of security systems are employed for consumer, commercial, industrial, government and military use cases. Security systems can utilize a variety of technologies, including mechanical, electrical, electromechanical, optical, laser and other techniques. Optical security systems are particularly adept at long stand-off surveillance where the sensor and operator can be located a safe distance away from threats. Typical optical security systems may include visible, infrared, millimeter wave, terahertz and x-ray imaging. These systems image different frequencies of energy in the electromagnetic spectrum.

Infrared, millimeter wave, terahertz and x-ray based security systems have the benefit of being able to image concealed objects under the clothing of subjects by imaging the contrast difference between the human body and the concealed object that may attenuate the imagery of the body's natural energy. For example, the human body emits, absorbs and reflects thermal, millimeter wave and terahertz energy in a sensor-observable fashion. In contrast, concealed objects such as explosives, weapons, contraband and the like block, absorb, reflect or otherwise attenuate the body's energy providing the imaging system with a contrasting image, either appearing darker or lighter than the body.

This capability is ideal for imaging suicide bombers, smugglers, and concealed objects such as firearms, contraband, currency, liquids and gels, and the like. One disadvantage of these optical systems and security systems in general, is they are typically not easily portable or rapidly deployable. Prior art concealed object imaging and detection systems are large, heavy and difficult to transport, are not one-man portable, and are thus time consuming and costly to deploy, and expensive and burdensome to transport. Furthermore, prior art concealed object imaging and detection systems are typically engineered for a particular environment, location or use case, making these systems costly in terms of application-specific engineering, training and support. These systems typically require support infrastructure such as electrical power, climate control, inspection areas/lanes, backdrops and the like, thereby limiting or eliminating their “ad hoc” or “on demand” responsiveness and capabilities.

Therefore, a need exists in the art for a light weight, one man portable concealed object detection system that can be easily, perhaps manually, transported to a deployment area and which requires a minimum of installation/support tools, manuals, system components, and traveling/storage containers.

Another need exists in the art for a security method and system for concealed object detection that is rapidly deployable by a minimum of personnel and supports quick setup with little to no field adjustments, testing or ground support. This place-and-go setup methodology greatly reduces the time required to deploy the system and the expense of installers, operators and support personnel.

Another need exists in the art for a concealed object detection security method and system that is flexible enough to be employed in a wide variety of use cases, locations and environments without additional engineering, site preparation, operator training or unit modifications. For example, a need exists for a method and system that is quickly deployable for indoor or outdoor conditions, daytime or nighttime conditions, humid or arid conditions, and the like. Those features are a large advantage over prior art systems that are required to be custom tailored for a particular deployment location or use case, by reducing or eliminating the costs involved in engineering and personnel training for each specific deployment.

Yet another need exists in the art for a security method and system for concealed object detection that is independently powered and can perform in deployments without external infrastructure such as power, utilities, air conditioning, or prior site preparation, thus reducing installation expense and time and presenting a common product and deployment methodology.

Another need exists in the art for a rapid deployment concealed object detection method and system that allows for cost savings due to the economies of scale in manufacturing, engineering and procurement that are realizable due to a flexible and generalized design.

However, in view of the prior art at the time the present invention was made, it was not obvious to those of ordinary skill in the pertinent art how the identified needs could be fulfilled.

### III. SUMMARY

In a particular embodiment, a method of detecting concealed objects using a handheld thermal imager is disclosed. The method includes capturing thermal sensor data from the handheld thermal imager, transmitting the thermal sensor data to a processor, and formatting the sensor data using the processor. The method also includes identifying a pre-determined relative difference between a temperature of a subject and a background scene and isolating the subject of interest from the background scene in the thermal sensor data using the processor. In addition, the method includes detecting a deviation in the temperature within a discrete area to suggest a size and location of the concealed object on the subject and filtering the thermal sensor data to generate a visual image displaying the concealed object on the subject of interest. A coaxial cable, Ethernet or wireless connection, some other means of data transmission, or any combination thereof, may be used for transmitting the thermal sensor data to the processor. An audible alarm may be generated when at least one concealed object is detected on the subject of interest. The method may be implemented using a laptop computer, desktop, or smartphone, for example, as the processor to process the thermal sensor data. The sensor data may include infrared frequencies. The handheld thermal imager may be mounted to a collapsible base. A pan-tilt mechanism on the collapsible base may be used to adjust a field of view of the handheld thermal imager via local, remote control, or any combination thereof.

In another particular embodiment, a system to detect a concealed object using a handheld thermal imager is disclosed. The system includes a handheld thermal imager configured to capture thermal sensor data, a transmitter to transmit the thermal sensor data to a processor and a formatting module to format the thermal sensor data. The system also includes an isolating module to isolate a subject of interest from a background scene in the thermal sensor data by identifying a pre-determined relative difference between a temperature of the subject and the background scene. A filtering module filters the thermal sensor data to generate an image displaying the concealed object by detecting a deviation in the temperature within a discrete area to suggest a size and location of the concealed object on the subject. In addition, the system may include a display for displaying the image to a user. The sensor data may include infrared frequencies and the display may be integral to the handheld thermal imager. An independent power source may be used to provide power to the concealed object imaging equipment. The system may also include a laser molecular trace detection sampler to determine a type of concealed object. The handheld thermal imager is adapted to be mounted to a collapsible base, which may include a pan-tilt mechanism to adjust a field of view of the handheld thermal imager via local, remote control, or any combination thereof.

In another particular embodiment, a non-transitory processor readable medium is disclosed. The processor readable medium includes processor instructions that are executable to cause a processor to receive captured thermal sensor data from a handheld thermal imager, format the sensor data to detect differences in relative temperatures, isolate a subject of interest from a background scene in the thermal sensor data, and filter the thermal sensor data to generate a visual image displaying the concealed object on the subject of interest on a display. In addition, the processor executable instructions are further executable to identify a pre-determined relative difference between a temperature of the subject and the background scene and to detect a deviation in the temperature within a discrete area to suggest a size and location of the concealed object on the subject. The processor executable instructions may generate an audible alarm when at least one concealed object is detected on the subject of interest.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular embodiment of a method to detect concealed objects using a handheld thermal imager;

FIG. 2 is a block diagram of a particular illustrative embodiment of a system to detect concealed objects using a handheld thermal imager;

FIG. 3 is a screen capture of a particular illustrative embodiment of the display generated by the method and system to detect concealed objects using a handheld thermal imager; and

FIG. 4 is a block diagram of an illustrative embodiment of a general computer system.

### V. DETAILED DESCRIPTION

The disclosed method and system includes a handheld thermal imager to capture sensor data. The method and system also includes quickly assembled components that are one man portable, rapidly deployable, and self-contained to process the sensor data. The components are quickly field-replaceable should one or more components become damaged or fail during transportation, storage or use.

The method and system provides a highly portable, “on demand” deployment design and construction with installation and setup time measured in minutes. For example, the system may be self-powered, or powered via on-site power, utilities or resources. Self-powered operation may be accomplished through the use of individual batteries on each system component requiring electrical power, or via a central power source such as battery, uninterruptable power supply, generator or solar blanket, or any combination thereof. Therefore, the self-powered system eliminates the reliance on external resources, utilities or infrastructure, reducing site preparation, infrastructure requirements, cost, and deployment effort.

The method and system can be operated as an entry screening device securing an area or zone from external objects carried-in concealed by subjects, as an exit screening device providing loss prevention of objects carried-out concealed by subjects, or any combination thereof. In addition, the system can be operated overtly, allowing the system's visible appearance and physical presence to serve as a deterrent, or operated covertly by virtue of the system's ability to be rapidly deployed with little or no adjustments, testing, or infrastructure, and the covert and stand-off nature of its imaging technologies.

The method and system can optionally include a computing element (e.g., processor) housed either in the display unit, the handheld thermal imager, or some other location so that the computing element can perform aided or automatic concealed object detection or image filtering and/or enhancement by virtue of image processing algorithms applied to the thermal imagery. In a particular embodiment, the method and system includes a handheld infrared thermal imager camera.

In addition, the method and system can be additionally utilized as an optical target tracker and/or target designator to ancillary equipment such as a laser molecular trace detection sampler, indicating which individuals or items should be sampled and the preferred location for sampling on the individual or item.

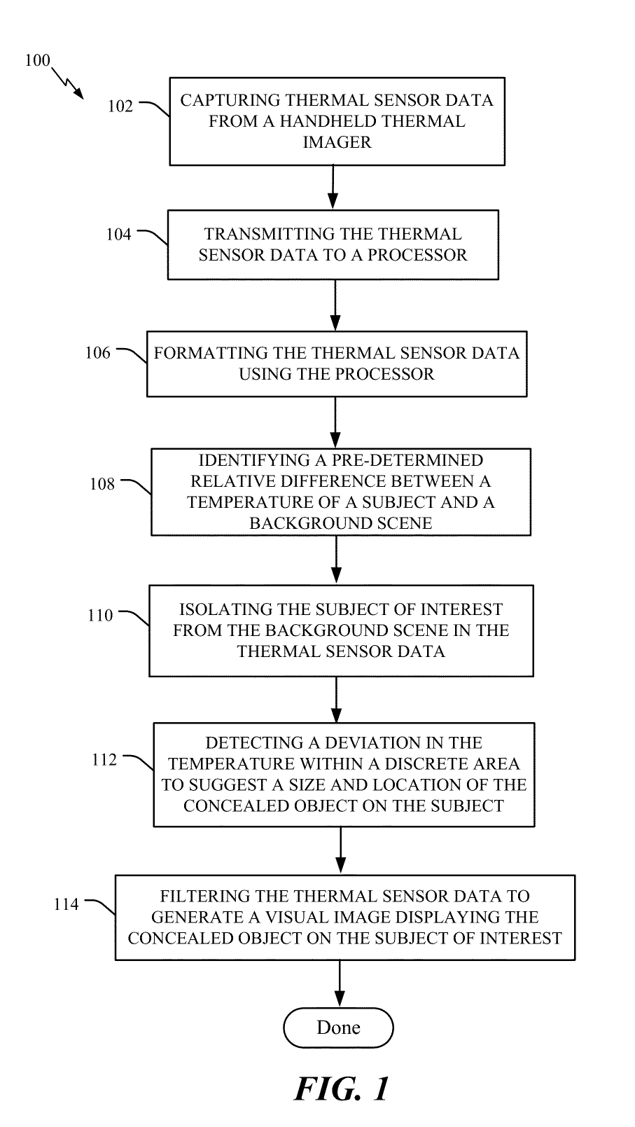

A flow diagram of a particular embodiment of a method to detect concealed objects using a handheld thermal imager is described in FIG. 1 and generally designated 100. At 102, thermal sensor data is captured from the handheld thermal imager. Moving to 104, the thermal sensor data is transmitted to a processor. The thermal sensor data is processed, at 106, using the processor. At 108, a pre-determined relative difference between a temperature of a subject and a background scene is identified. The subject of interest is isolated, at 110, from the background scene in the thermal sensor data using the processor. A deviation in the temperature is detected within a discrete area to suggest a size and location of the concealed object on the subject, at 112. The thermal sensor data is filtered, at 114, to generate a visual image displaying the concealed object on the subject of interest.

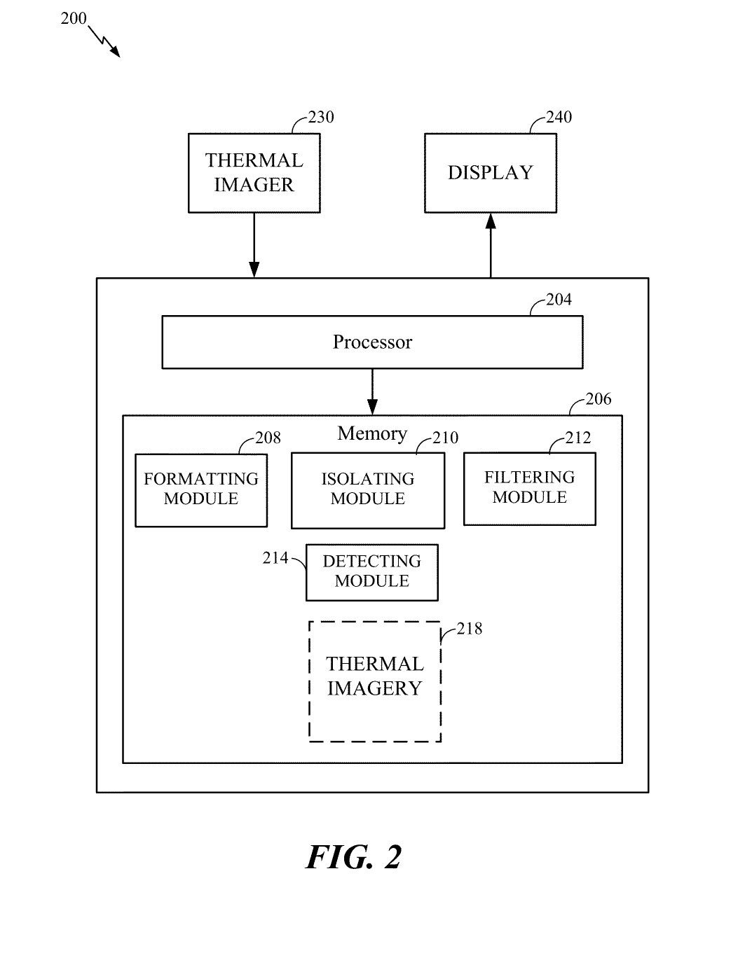

Referring to FIG. 2, a particular illustrative embodiment of a system to detect concealed objects using a handheld thermal imager is depicted and generally designated 200. The system 200 includes a processor 204 that is in communication with a thermal imager 230, where a memory 206 may be adapted to store thermal imagery 218. In a particular illustrative embodiment, the content of the thermal imagery 218 may include thermal sensor data transmitted by the handheld thermal imager 230 to the processor 204. A formatting module 208 may be used to format the thermal sensor data to generate thermal imagery 218, an isolation module 210 may be used to isolate a subject of interest from a background scene within the thermal imagery 218, a detecting module 214 may be used to detect a deviation in the temperature within a discrete are to suggest a size and location of the concealed object on a subject, and a filtering module 212 may be used to generate a visual image displaying the concealed object on the subject of interest. In addition, a display 240 may be in direct communication with the processor 204, for displaying the visual image of the concealed object on the subject of interest to the operator. The display 240 may include indicator lights in place of, or in combination with, displaying a visual image of the concealed object on the subject of interest. For example, a green indicator light may be illuminated when no concealed object is detected and a red light may be illuminated when a concealed object is detected.

The modules 208, 210, 212, 214 may be implemented in hardware, firmware, software, other programmable logic, or any combination thereof. The memory 206 includes media that is readable by the processor 204 and that stores data and program instructions of the software modules 208, 210, 212, 214 that are executable by the processor 204. Additionally, the system 200 may include a display 240, for example, a cathode ray tube (CRT) display, liquid crystal display (LCD), light emitting diode (LED) display, plasma display, or other display device that is accessible to the processor 204 to display the thermal imagery 218 to the operator.

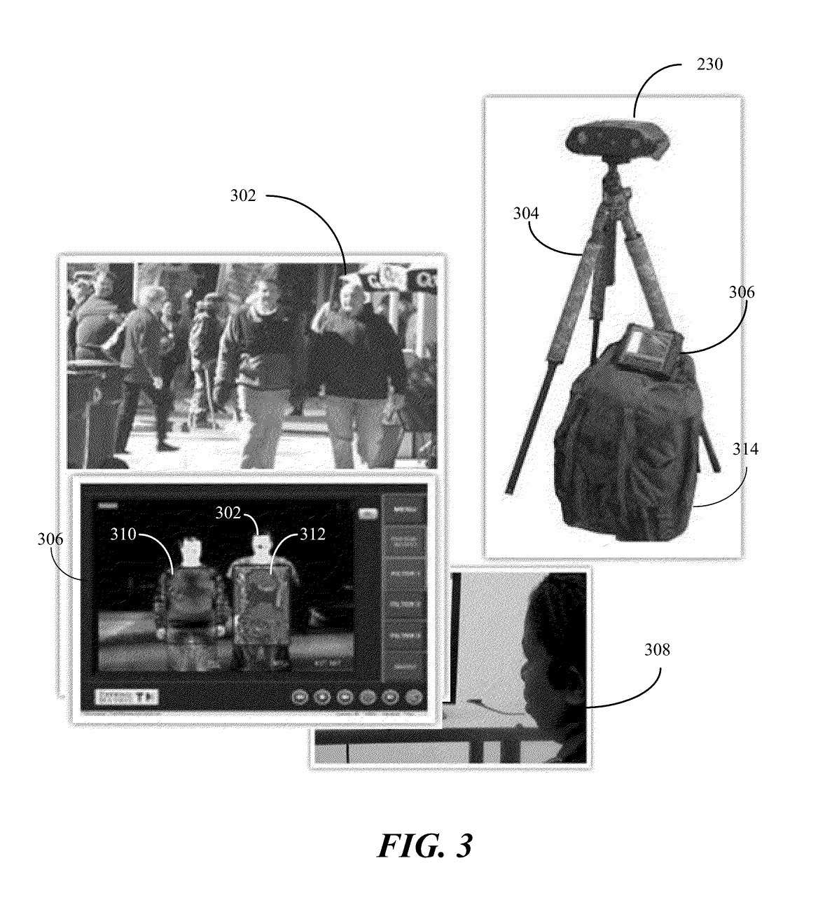

Referring to FIG. 3, the system includes unique components and approaches that allow realization of a rapidly deployable, one man portable, mobile concealed object detection system using a handheld thermal imager 230. The system includes components, techniques, designs and construction that separately or together provide a controlled deployment within which the system optimally operates. The handheld thermal imager 230 is positioned so that it can image one or more subjects 302 that may be carrying a concealed object. The handheld thermal imager 230 is configured to capture thermal sensor data.

The handheld thermal imager 230 may be mounted to a support base or tripod 304. The handheld thermal imager 230 may be connected to a display unit 306 via a cable or other, perhaps wireless, data transmission scheme. A transmitter may be used to transmit the thermal sensor data to a processor 204 that is in communication with the display unit 306. Alternatively, the handheld thermal imager 230 may incorporate the display unit 306 rather than remotely. The processor 204, memory 206, and modules 208, 210, 212, 214 may also be integrated directly into the thermal imager 230 thereby eliminating a separate computer processor, display and cables between the thermal imager 230 and display unit 306. The thermal sensor data generally includes infrared frequencies. As explained above, a formatting module 208 may be used to format the thermal sensor data so that the operator 308 can view the thermal imagery 310 from the imager 230 on the display unit 306. An isolating module 210 may be used to isolate a subject of interest 302 from a background scene in the thermal sensor data by identifying a pre-determined relative difference between a temperature of the subject and the background scene. A filtering module 212 may be used to filter the thermal sensor data to generate a filtered image 312 displaying the concealed object by detecting a deviation in the temperature within a discrete area to suggest a size and location of the concealed object on the subject 302. Accordingly, should the operator 308 viewing the display unit 306 recognize the presence of a concealed object on the subject 302, the operator 308 can then direct the subject 302 to reveal or divest himself of the concealed object, or otherwise take appropriate action. During transport or storage of the system, a container 314 such as a rucksack may be used to contain the handheld thermal imager 230, support base or tripod 304, display unit 306, cable (not shown) and other items. The system is lightweight so as to be one man portable. Alternately, the system may be transported within multiple containers or without the use of containers, such as in the case of a handheld thermal imager 230 with integral display.

Power for the system may be supplied by separate batteries installed in the handheld thermal imager 230 and display unit 306 respectively, or supplied via an independent power source such as a central battery, generator, uninterruptable power supply, line voltage transformer, solar blanket, vehicle battery, or some combination of thereof.

The handheld thermal imager 230 may be positioned at a safe standoff distance from the subject 302 and the operator 308 views the subject 302 as the subject 302 is in proximity to the detection area, which may be the entrance or exit of a controlled area, or a security checkpoint, for example. The handheld thermal imager 230 is used to image the stationary or moving subject 302 as the subject loiters near and/or transverses the detection area. An optional pan-tilt mechanism can be mounted to the handheld thermal imager 230 and/or base 304 to allow the imager 230 to pan and tilt via local or remote control.

In another particular embodiment, a laser molecular trace detection sampler (not shown) may be implemented with the system. Similar to the handheld thermal imager 230, the laser molecular trace detection sampler is connected to the processor 204 and display unit 306 via a transmitter. A pan-tilt mechanism may be mounted to the laser molecular trace detection sampler to allow the laser molecular trace detection sampler to pan and tilt via local or remote control, either manually, algorithmically, or both. As the handheld thermal imager 230 images a subject 302, thermal sensor data is transmitted via the transmitter to the processor 204 and display unit 306, to process the thermal sensor data and display the image. Should a concealed object be detected, the laser molecular trace detection sampler is focused and adjusted manually, algorithmically or both towards the location of the detected concealed object on the subject 302 using the respective pan-tilt mechanism.

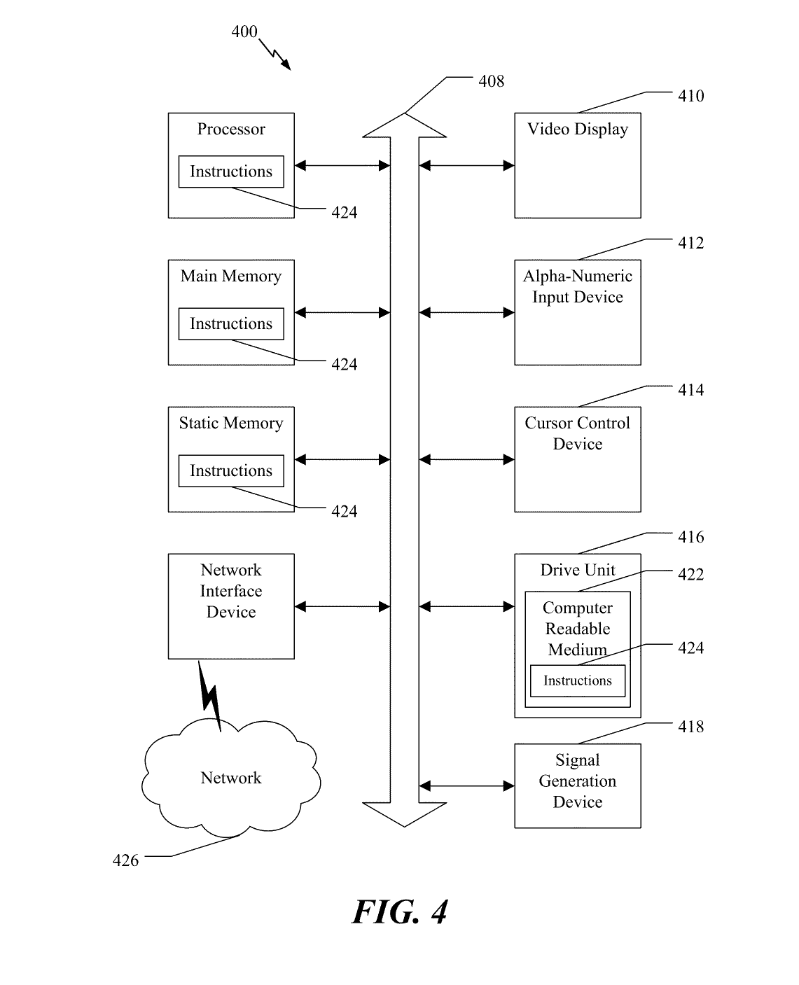

Referring to FIG. 4, an illustrative embodiment of a general computer system is shown and is designated 400. The computer system 400 can include a set of instructions that can be executed to cause the computer system 400 to perform any one or more of the methods or computer based functions disclosed herein. The computer system 400, or any portion thereof, may operate as a standalone device or may be connected, e.g., using a network, to other computer systems or peripheral devices.

In a networked deployment, the computer system may operate in the capacity of a server, such as a video server or application server, or a media device. The computer system 400 can also be implemented as or incorporated into various devices, such as a personal computer (PC), a personal digital assistant (PDA), a mobile device, a palmtop computer, a laptop computer, a desktop computer, a communications device, a wireless telephone, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics-processing unit (GPU), or both. Moreover, the computer system 400 can include a main memory 404 and a static memory 406 that can communicate with each other via a bus 408. As shown, the computer system 400 may further include a video display unit 410, such as a liquid crystal display (LCD), a flat panel display, a solid-state display, or a cathode ray tube (CRT). Additionally, the computer system 400 may include an input device 412, such as a keyboard, and a cursor control device 414, such as a mouse. The computer system 400 can also include a disk drive unit 416, a signal generation device 418, such as a speaker or remote control, and a network interface device 420.

In a particular embodiment, as depicted in FIG. 4, the disk drive unit 416 may include a computer-readable medium 422 in which one or more sets of instructions 424, e.g. software, can be embedded. Further, the instructions 424 may embody one or more of the methods or logic as described herein. In a particular embodiment, the instructions 424 may reside completely, or at least partially, within the main memory 404, the static memory 406, and/or within the processor 402 during execution by the computer system 400. The main memory 404 and the processor 402 also may include computer-readable media.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

1. A method to detect concealed objects using a handheld thermal imager, the method comprising:
capturing thermal sensor data from the handheld thermal imager;
transmitting the thermal sensor data to a processor;
formatting the thermal sensor data;
using a pre-determined relative difference between a temperature of a subject and a temperature of a background scene of the thermal sensor data to isolate the subject of interest from the background scene in the thermal sensor data;
isolating the subject of interest from the background scene in the thermal sensor data to display thermal imagery of the subject of interest;
detecting a relative deviation in the temperature within a discrete area on the subject of interest to suggest a size and location of the concealed object on the subject of interest;
processing the thermal sensor data within the discrete area using image processing algorithms when the relative deviation in the temperature within the discrete area suggests a presence of the concealed object;
displaying a visual variable boundary around the discrete area, wherein the visual variable boundary changes in size and location based on the size and location of where the concealed object is on the subject of interest in order to assist an operator to recognize the presence of the concealed object; and
determining a type of the concealed object using a laser trace detection sampler.

2. The method of claim 1, further comprising providing a coaxial cable for transmitting the thermal sensor data to the processor.

3. The method of claim 1, further comprising providing an Ethernet cable for transmitting the thermal sensor data to the processor.

4. The method of claim 1, further comprising providing a wireless connection for transmitting the thermal sensor data to the processor.

5. The method of claim 1, further comprising generating an audible alarm when at least one concealed object is detected on the subject of interest.

6. The method of claim 1, wherein the processor is a laptop computer.

7. The method of claim 1, wherein the processor is an embedded computing element.

8. The method of claim 1, wherein the sensor data includes infrared frequencies.

9. The method of claim 1, further comprising mounting the handheld thermal imager to a collapsible base.

10. The method of claim 9, further comprising using a pan-tilt mechanism on the collapsible base to adjust a field of view of the handheld thermal imager via local control, remote control, manual control, algorithmic control or any combination thereof.

11. A system to detect a concealed object using a handheld thermal imager, the system comprising:
the handheld thermal imager configured to capture thermal sensor data;
a transmitter to transmit the thermal sensor data to a processor;
a formatting module to format the thermal sensor data;
an isolating module to isolate and to display thermal imagery of a subject of interest from a background scene in the thermal sensor data by using a pre-determined relative difference between a temperature of the subject and a temperature of the background scene of the thermal sensor data;
the processor to enhance the thermal sensor data within a discrete area when a relative deviation in the temperature within the discrete area suggests a size and location of the concealed object;
a display to display a visual variable boundary around the discrete area, wherein the visual variable boundary changes in size and location based on the size and location of where the concealed object is on the subject of interest in order to assist an operator to recognize the presence of the concealed object; and
a laser trace detection sampler to determine a type of the concealed object.

12. (canceled)

13. The system of claim 12, wherein the sensor data includes infrared frequencies.

14. The system of claim 12, wherein the display is integral to the handheld thermal imager.

15. The system of claim 12, further comprising an independent power source to provide power to the system.

16. (canceled)

17. The system of claim 12, further comprising a collapsible base to mount the handheld thermal imager.

18. The system of claim 17, wherein the collapsible base further comprising a pan-tilt mechanism to adjust a field of view of the handheld thermal imager via local, remote control, or any combination thereof.

19. A non-transitory processor readable medium having processor instructions that are executable to cause a processor to:
receive captured thermal sensor data from a handheld thermal imager;
format the sensor data to detect differences in relative temperatures;
isolate a subject of interest from a background scene in the thermal sensor data by using a pre-determined relative difference between a temperature of the subject of interest and a temperature of the background scene of the thermal sensor data;
display thermal imagery of the subject of interest that has been isolated from the background scene;
detect a deviation in the temperature within a discrete area on the subject of interest to suggest a size and location of the concealed object on the subject;
process the thermal sensor data within the discrete area when the deviation in the temperature within the discrete area suggests a presence of the concealed object;
display a visual variable boundary around the discrete area, wherein the visual variable boundary changes in size and location based on the size and location of where the concealed object is on the subject of interest in order to assist an operator to recognize the presence of the concealed object; and
determine a type of the concealed object using a laser trace detection sampler.

20. (canceled)

21. (canceled)

22. The non-transitory processor readable medium of claim 19, wherein the processor executable instructions are further executable to generate an audible alarm when at least one concealed object is detected on the subject of interest.
